(19) United States
(12) Patent Application Publication
(10) Pub. No.: US 2018/0263400 A1
(43) Pub. Date: Sep. 20, 2018

(54) SLOW COOKER

(71) Applicant: National Presto Industries, Inc., Eau Claire, WI (US)

(72) Inventor: Michael R. Berge, Eau Claire, WI (US)

(21) Appl. No.: 15/925,341

(22) Filed: Mar. 19, 2018

Related U.S. Application Data
(60) Provisional application No. 62/473,072, filed on Mar. 17, 2017.

(51) Int. Cl. A47J 27/00

(52) U.S. Cl. CPC A47J 27/002; A47J 39/00; A47J 27/004

(57) ABSTRACT

A slow cooker having a cooking vessel, a handle assembly and a lid assembly whereby the handle assembly rotatably locks the lid assembly over the cooking vessel and related methods of use. The handle assembly is rotatably positionable between a lowered position wherein a user can rotatably manipulate the lid assembly between open and closed positions relative to the cooking vessel and a travel position whereby the handle assembly rotatably locks the lid assembly in a sealed, closed position relative to the cooking vessel. The handle assembly can include single or dual handle configuration that allow a user to carry the slow cooker with the handle assembly in the travel position. The lid assembly can include a removable utensil tray that allows for one or more kitchen utensils to be retained by a flexible resilient member as the slow cooker is carried in the travel position.

### CROSS-REFERENCE TO RELATED APPLICATION

The present application claims the benefit of U.S. Provisional Application No. 62/473,072, filed Mar. 17, 2017, which is hereby incorporated herein in its entirety by reference.

### TECHNICAL FIELD

The present invention is directed to portable cooking appliances for the preparation of food. More specifically, the present invention is directed to a portable slow cooker having a rotatable handle assembly that lockably engages a lid assembly when the slow cooker is being carried or transported to a serving location.

### BACKGROUND

Conventional slow cookers, or “crock pots”, include a cooking vessel with a lid and a heating structure that houses the cooking vessel. The heating structure provides heat to the cooking vessel via heating element. In use, food that is to be cooked, warmed, or kept warm is places within the cooking vessel and heating structure heats the cooking vessel and accordingly heats the food contained within. A lid is generally placed on the cooking vessel after the food is placed within the cooking vessel to contain heat and moisture and provide a barrier against outside contaminants. Often, slow cookers are designed such that they can be made portable in order bring heated food, or food to be heated, to different locations other than the user's own kitchen.

However, portable slow cookers are difficult to carry because they are relatively heavy and cumbersome due to the removable lid detaching from the cooking vessel during transportation. The industry has accommodated these issues by providing handles attached to the slow cookers. To address the issue of unintentional lid detachment, portable slow cookers are sometimes fitted with straps or other fixation mechanisms. To transport a conventional portable slow cooker, a user places the lid on the cooking vessel, straps the lid securely the cooking vessel or heating structure, then picks up the portable slow cooker using the handles. Then, when at the intended destination, the user places the portable slow cooker down, releases the straps or other fixation mechanism to enable the user to remove the lid. While the strap or other fixation mechanism alleviates the issue of unintentional release of the lid, it is an additional and cumbersome step for the user.

Additionally, conventional lids present another issue. While conventional lids contain heat and moisture, they generally collect considerable condensate during operation. Condensate is primarily water but can contain food, oil, grease or other particles. Then, when a user wishes to access the food contained within the cooking vessel and lifts the lid off of the cooking vessel, the condensate accumulates and drips off the lid onto areas other than the cooking vessel creating a mess.

Therefore there exists a need in the industry to create a less burdensome lid fixation mechanism and a device, method, or system of alleviating messes created by condensate dripping off the lid when the user wishes to access the food contained within the cooking vessel.

### SUMMARY

Embodiments described herein relate to a portable slow cooker having a cooking vessel, housing, and lid. Embodiments further include one or more handles coupled to the housing, one or more lid fixation mechanisms, and one or more lid drip trays arranged on the housing. In embodiments, the one or more handles are rotatably coupled to the housing such that they have a lower position and are movable to a travel position. In embodiments, the one or more handles are also configured to include a lid fixation mechanism which fixes the lid to the housing when the one or more handles are in the travel position and releases the lid fixation mechanism when the one or more handles are in the lower position.

In some embodiments, the lid is rotatably coupled to the housing such that the lid rotates to allow access to an inner cooking volume of a cooking vessel while remaining coupled to the housing. In embodiments, the lid has a closed position where the lid covers the food containment portion of the cooking vessel, an open position where the lid is not covering the food containment portion, and various positions between the closed position and the open position. In embodiments, a drip tray is arranged on the housing such that when the lid is in the open position, the drip tray catches any accumulated condensate that drips from the lid.

Generally, a slow cooker of the present invention includes a housing, a cooking vessel, a lid assembly and a handle assembly, whereby the handle assembly is rotatably coupled to the housing. Generally, the handle assembly is rotatably positionable between a lowered position wherein a user can rotatably manipulate the lid assembly between open and closed positions relative to the cooking vessel and a travel position whereby the handle assembly rotatably locks the lid assembly in a sealed, closed position relative to the cooking vessel. The handle assembly can comprise either single or dual handles that are configured to allow a user to carry the slow cooker with the handle assembly in the travel position. The lid assembly can include a removable utensil tray that allows for one or more kitchen utensils to be retained by a flexible resilient member as the slow cooker is carried in the travel position.

Representative methods of the present invention generally involve rotatably lowering a hinged lid assembly to cover a cooking vessel. With the lid assembly covering the cooking vessel, a handle assembly can be rotated from a lowered position to a travel position wherein the handle assembly lockably engages the lid assembly. The method can further comprise grasping the handle assembly to carry the cooking vessel to a serving location with the lid assembly lockably engaged over the cooking vessel by the handle assembly. The method can further comprise rotating the handle assembly to a lowered position whereby the lid assembly can be rotated to expose an upper opening of the cooking vessel. In some embodiments, the method can further comprise retaining a serving utensil in a utensil tray that is detachable mounted in an upper surface on the lid assembly.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is an isometric view of a portable slow cooker.

FIG. 2 is a front view of a portable slow cooker.

FIG. 3 is a side view of a portable slow cooker.

FIG. 4 is a bottom view of a portable slow cooker.

FIG. 5 is a rear isometric view of a portable slow cooker.

FIG. 6 is an isometric view of an open portable slow cooker.

FIG. 7 is a side view of an open portable slow cooker.

FIG. 8 is a side view of a lid for a portable slow cooker.

FIG. 9 is an isometric view of a utensil tray for a portable slow cooker.

FIG. 10 is a side view of a utensil tray for a portable slow cooker.

FIG. 11 is a top view of a utensil tray for a portable slow cooker.

FIG. 12 is a side view of a utensil tray for a portable slow cooker.

FIG. 13 is an isometric view of a portable slow cooker.

FIG. 14 is an isometric view of a portable slow cooker.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments described herein relate to a portable slow cooker having a cooking vessel, housing, and lid. Embodiments further include one or more handles coupled to the housing, one or more lid fixation mechanisms, and one or more lid drip trays arranged on the housing.

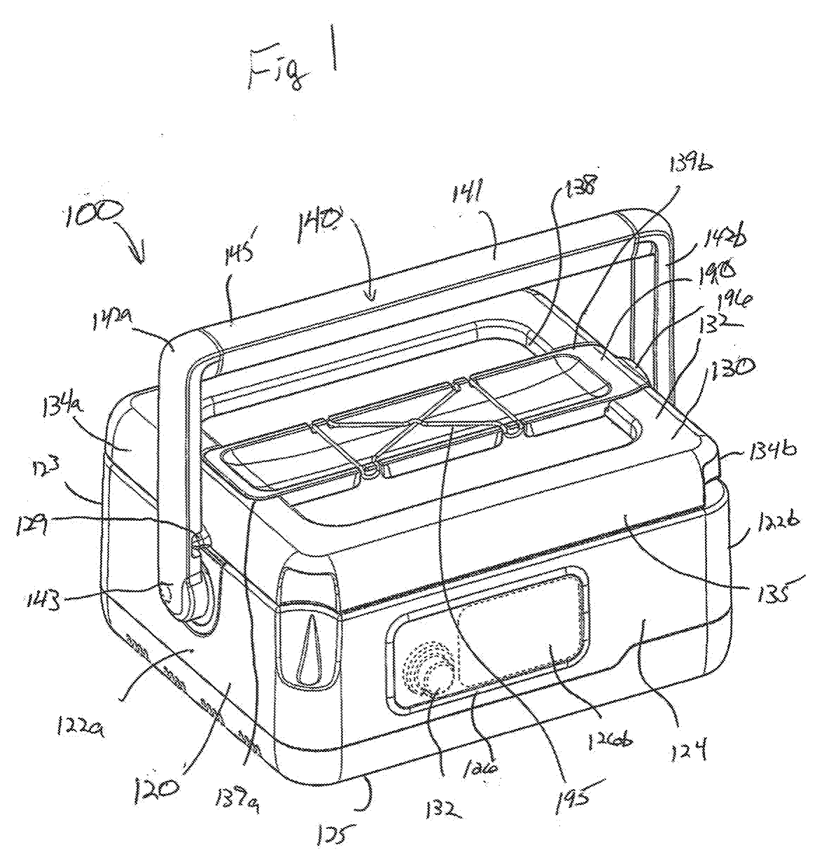

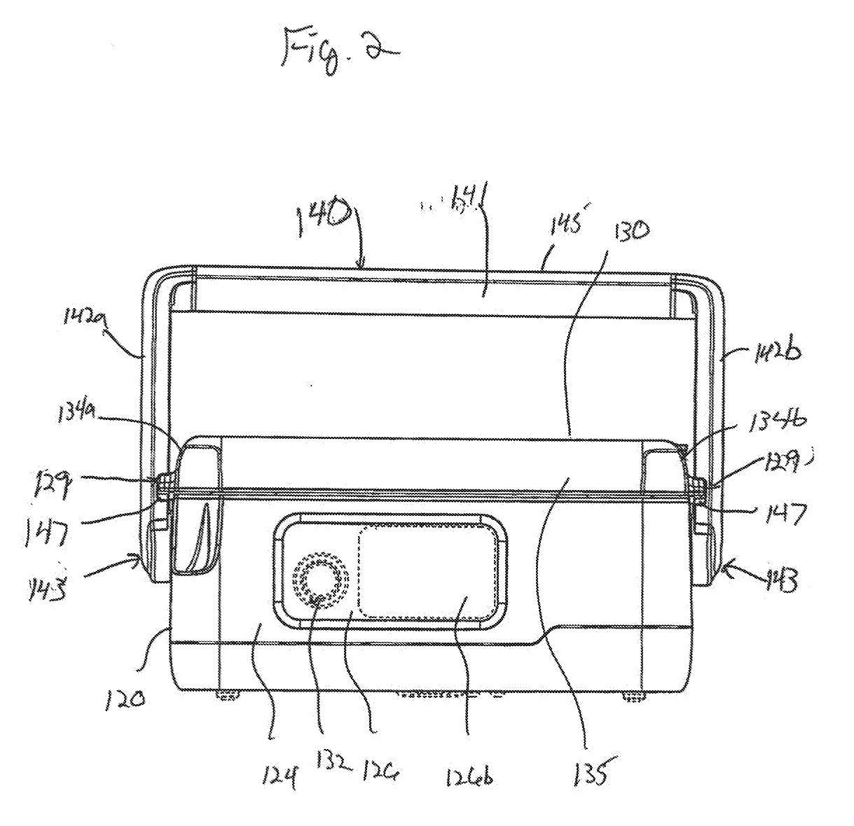

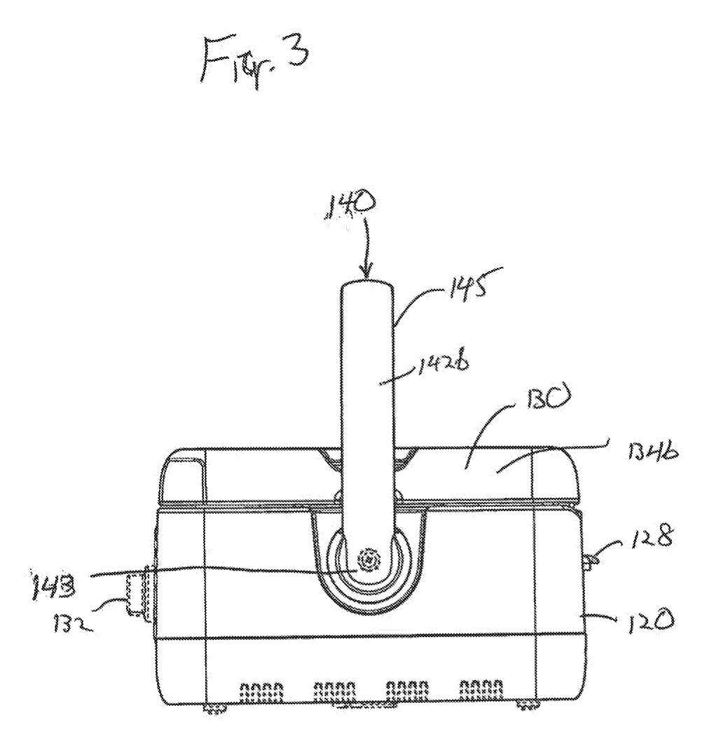

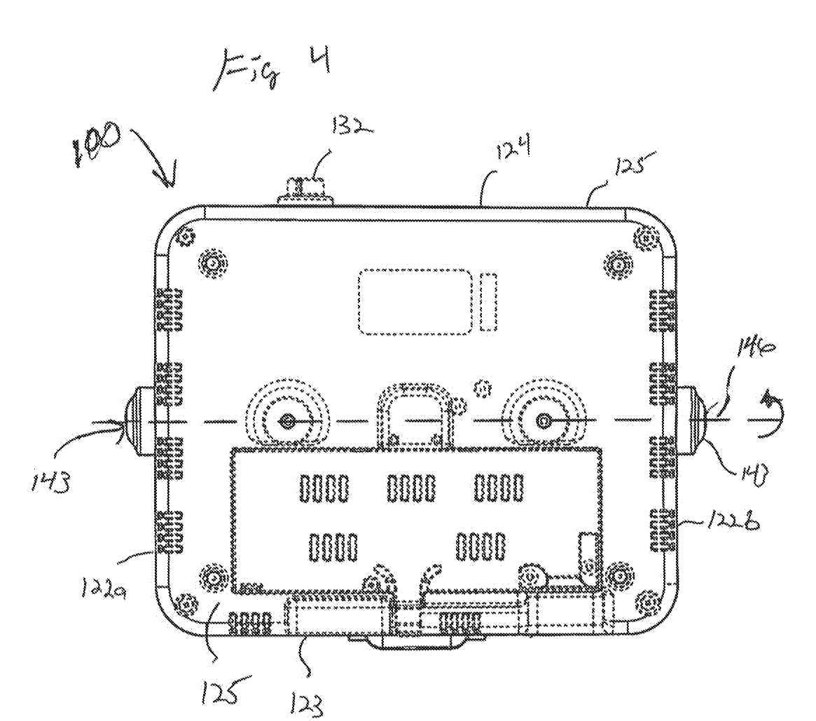

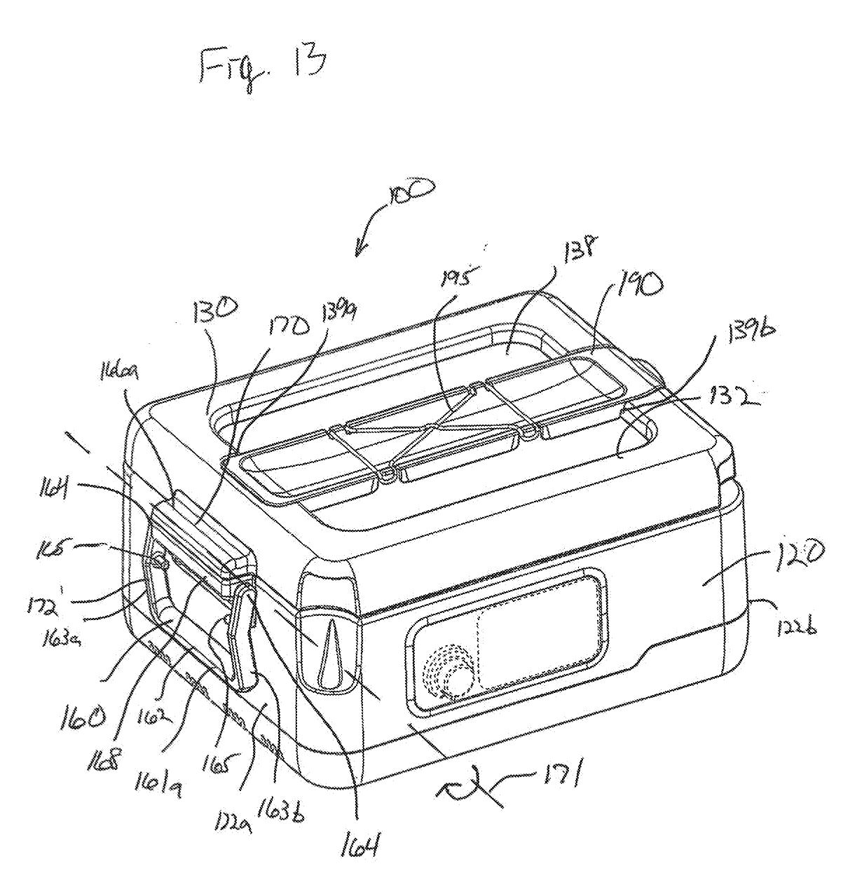

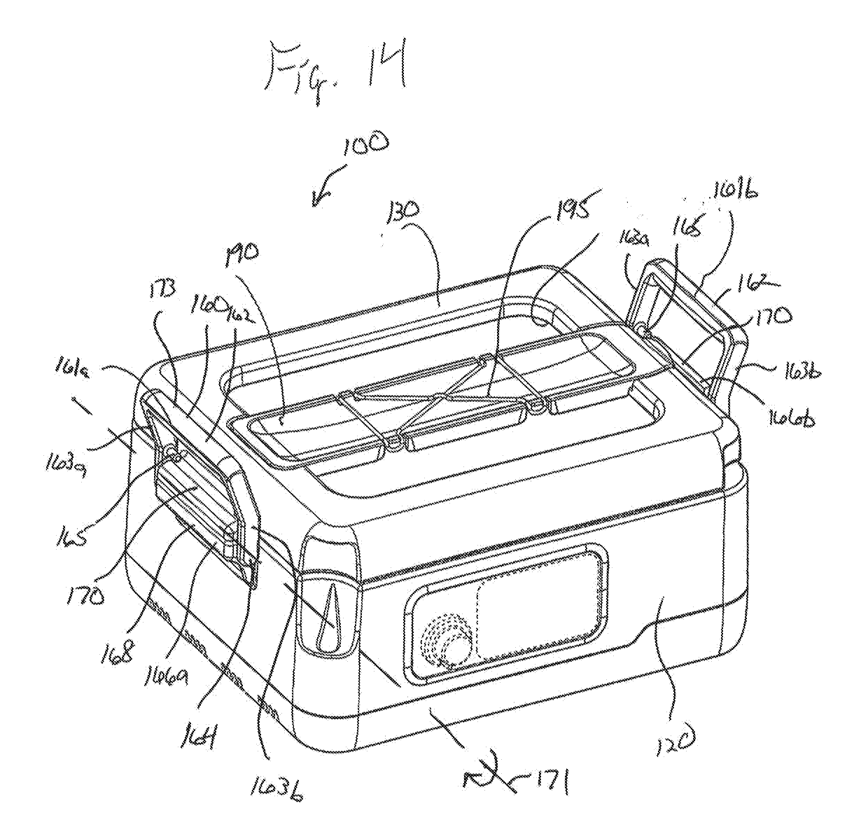

Referring now to FIGS. 1-7, an embodiment of the portable slow cooker 100 includes a cooking vessel 110, housing 120, and lid assembly 130. The embodiment depicted in FIGS. 1-7 further includes a single handle assembly 140, though as illustrated in FIGS. 13-14, a handle assembly 160 can include two individually operated handle members.

As seen in FIGS. 1-7, cooking vessel 110 generally defines an upper opening 111 that provides access to an internal cooking volume 112 for receiving a food item to be cooked and/or heated. In some embodiments, upper opening 111 can be fabricated to include an upper sealing surface 113. Cooking vessel 110 can be fabricated of conventional materials, for example, various ceramic and/or metallic conductive materials that are suited for food contact and are preferably easy to clean. In some embodiments, the cooking vessel 110 can be removable from the housing 120 to facilitate clean up following use. Though not shown, it will be understood that the housing 120 generally encloses a conventional heating element, for example, a resistive heat element that can be located in proximity to, or in direct contact with the cooking vessel 110 such that electrical energy can be converted into heat energy that is used to cooking/heating food items placed within the internal cooking volume 112. In addition to the heating element, the slow cooker 100 can make use of a temperature sensing element, for example, conventional thermocouples or RTD's (Resistance Temperature Detectors) that are operably connected to a controller, either an analog or digital controller, that allow the temperature of slow cooker 100 to be controlled. In some embodiments, the slow cooker 100 can include a temperature selector, for example, buttons or a dial 132 that allow a user to choose what a desired cooking/heating temperature for the slow cooker 100.

As seen in FIGS. 1-7, housing 120 generally includes an upper housing surface 121, a pair of opposed side walls 122a, 122b, a rear wall 123, a front wall 124 and a lower housing surface 125. Housing 120 is preferably formed of materials that are poor conductors of heat such as, for example, polymeric materials. Preferably, the opposed side walls 122a, 122b, rear wall 123 and front wall 124 define a substantially parallelogram perimeter 125 such as square or rectangular with the opposed side walls 122a, 122 being arranged in substantially parallel relation and the rear wall 123 and front wall 124 arranged in substantially parallel relation. Front wall 124 can include a display portion 126 for mounting the dial 132. Display portion 126 can further comprise a writing surface 126b, that allows a user to write a description of the food item contained within the internal cooking volume 111 such that the lid 130 need not be opened, and heat released, to identify what is being heated/cooked. Rear wall 123 can define a wall cavity 127 for positioning a drip tray 128. Drip tray 128 can be rotatably or slidably mounted within the wall cavity 127.

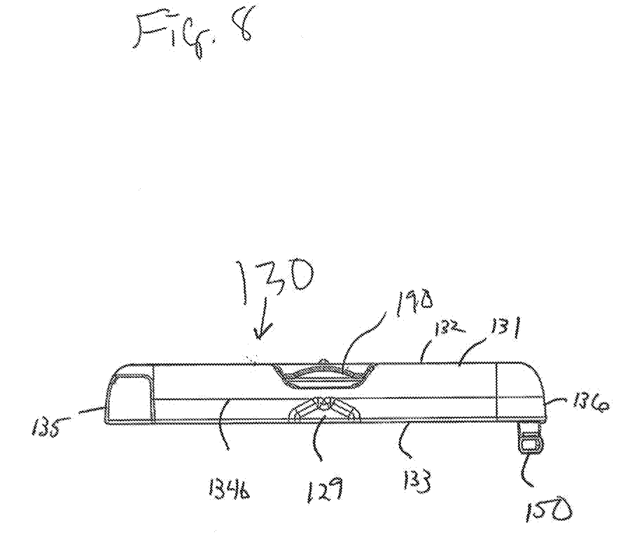

As seen in FIGS. 1-3 and 5-8, lid assembly 130 generally comprises a lid body 131 having a lid perimeter that substantially resembles the rectangular or square perimeter 125 of the housing 120. Lid assembly 131 generally includes an upper lid surface 132, a lower lid surface 133, a pair of opposed lid side surfaces 134a, 134b, a lid front surface 135 and a lid rear surface 136. Lower lid surface 133 can include a compressible sealing gasket 137 that is sized and shaped to match the upper sealing surface 113. Upper lid surface 132 can define a lid recessed portion 138 including a pair of lid cutouts 139a, 139b. Each of the opposed lid side surfaces 134a, 134b can further define a retention tab 129.

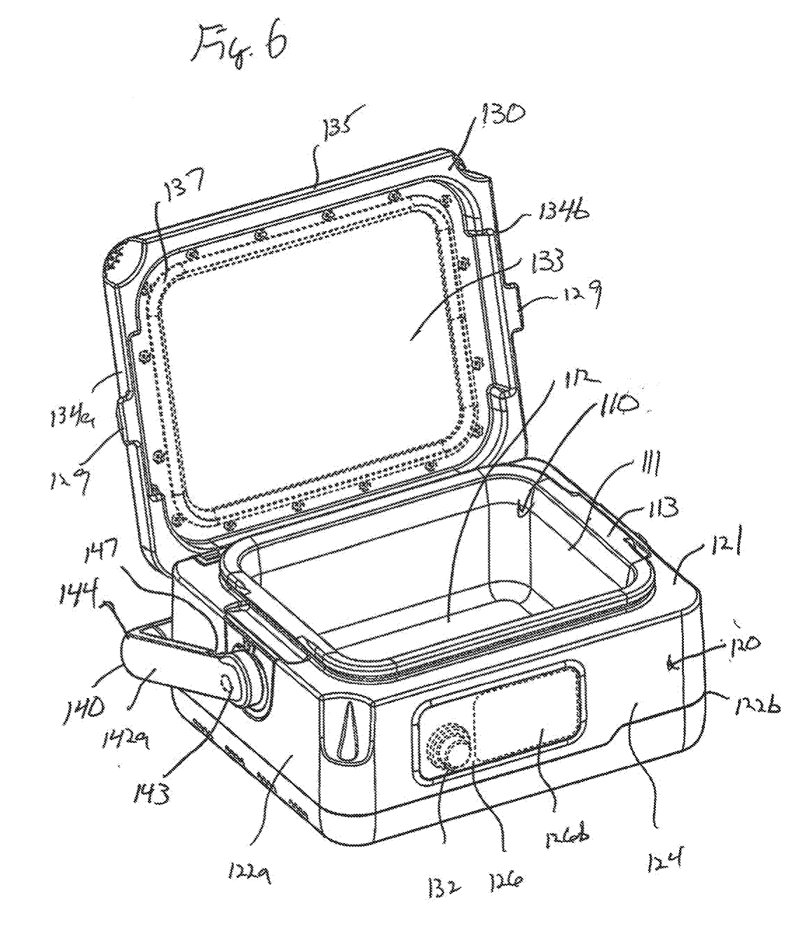

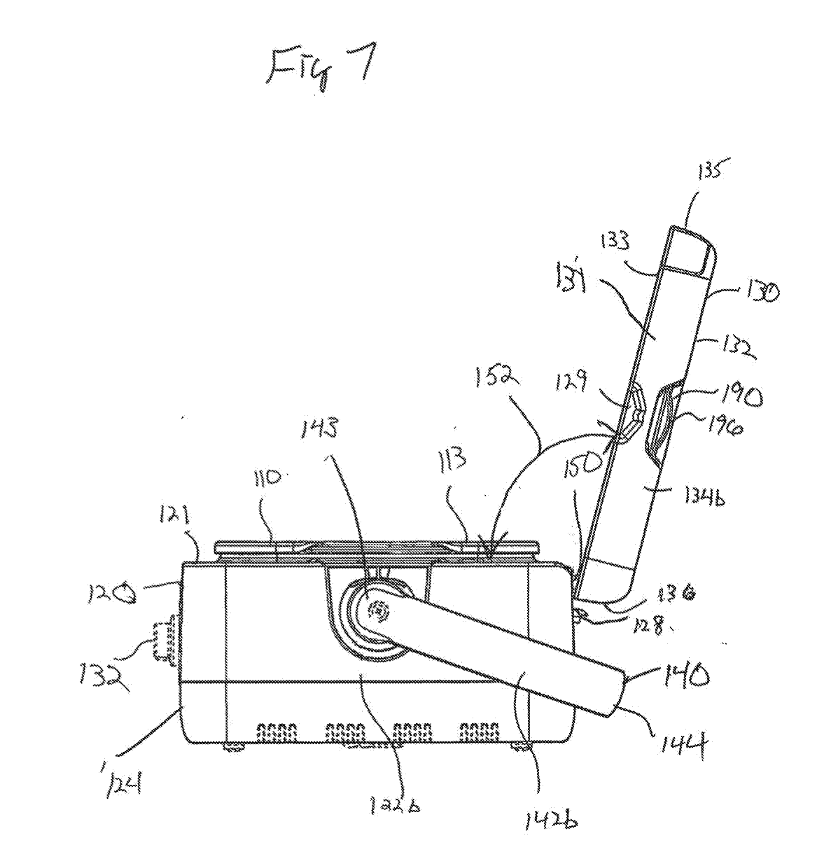

As seen in FIGS. 1-7, the handle assembly 140 generally comprises a carrying arm 141 positioned between a pair of opposed side arms 142a, 142b. Each of the opposed side arms 142a, 142b terminates at a fixation portion 143, wherein the fixation portions 143 are rotatably coupled to the corresponding opposed side wall 122a, 122b. With the opposed side arms 142a, 142b rotatably coupled to the opposed side walls 122a, 122b, the handle assembly 140 can be rotated so as to selectively transition between a lowered position 144 as seen in FIGS. 6 and 7 and a travel position 145 as seen in FIGS. 1-5. Generally, the handle assembly 140 rotates about a rotation axis 146 defined between the two fixation portions 143, whereby the rotation axis 146 is generally parallel to the rear wall 123 and front wall 124. Each of the opposed side arms 142a, 142b generally define an engagement cavity 147.

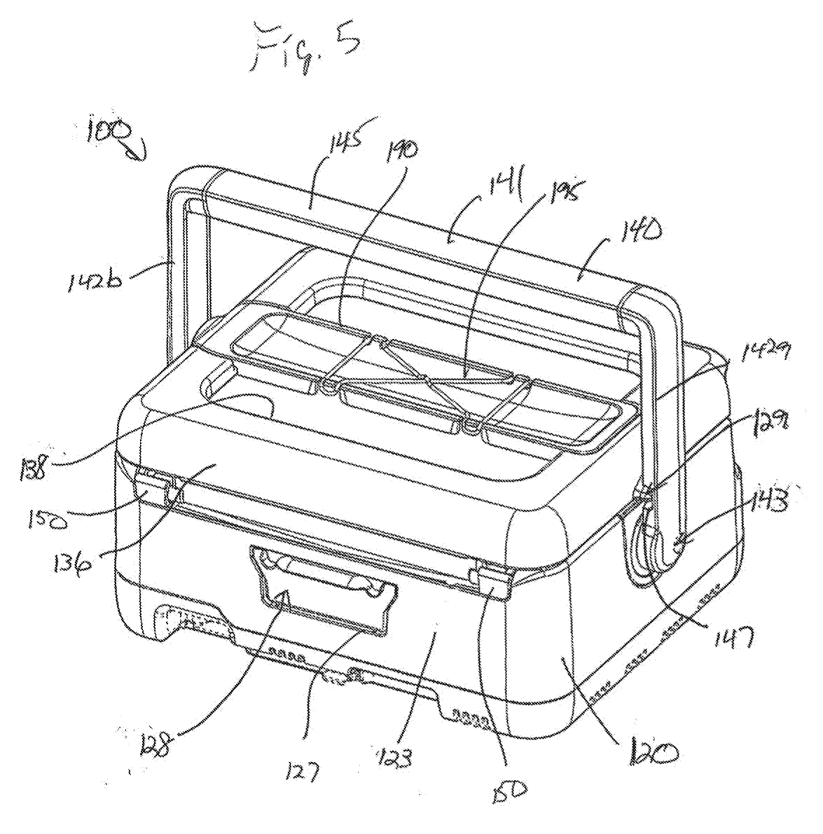

To use the slow cooker 100, a user positions the handle assembly 140 in the lowered position 144 and rotates the lid assembly 130 relative to the housing 120 using a hinge assembly 150 that couples the lid assembly 130 to the housing 120 as shown in FIGS. 5 and 7. Preferably, the hinge assembly 150 allows the lid body 131 to be detached from the housing 120 to facilitate cleanup following use. Generally the lid assembly 130 is rotated to a self-retaining open position 151 wherein a lid rotation path 152 exceeds 90° relative to the rear wall 123. At this point, the user can fill the internal cooking volume 112 with the food item to be cooked/heated and the dial 132 can be rotated to a desired temperature.

Next, the user can rotate the lid assembly 130 about the hinge assembly 150 such that that the lower lid surface 133 is directed toward the upper housing surface 121. As the lower lid surface 133 covers the upper opening 111, the sealing gasket 137 comes into contact with the upper sealing surface 113. The user then grasps the handle assembly 140 and begins to rotatably transition the handle assembly 140 from the lower position 144 toward the travel position 145. As the handle assembly 140 approaches the travel position the 145, the engagement cavity 147 on each of the opposed side arms 142a, 142b is rotated over and captures the corresponding retention tab 129. As the retention tabs 129 are lockably captured in the engagement cavities 147, the sealing gasket 137 is compressed against the upper sealing surface 113 to form a seal that is both air and liquid tight so as to retain both heat and liquids within the internal cooking volume 112. With the handle assembly 140 in the travel position 145, the lid assembly 130 remains lockably sealed to the cooking vessel 110 and the user can transport the slow cooker 100 to a serving location by grasping the carrying arm 141 and carrying the sealed slow cooker 100.

At the serving location, the user can place the slow cooker 100 on a serving surface, for example, a counter or table. The user then grasps the handle assembly 140 and rotatably transitions the handle assembly 140 from the travel position 145 toward the lower position 144. As the handle assembly 140 approaches the lower position 144, the engagement cavities 147 on each of the opposed side arms 142a, 142b are directed away from the retention tabs 129, whereby the lid assembly 130 is no longer lockably retained by the handle assembly 140. At this point, the user can rotate the lid assembly 130 toward the open position 151 such that the food item within the internal cooking volume 112 can be served. When the lid assembly 130 is in the open position 151, any condensation that occurred when the lid assembly was covering the upper opening 111 can drip into and be captured by the drip tray 128.

In an alternative embodiment of slow cooker 100 as shown in FIGS. 13 and 14, handle assembly 140 can be replaced with a handle assembly 160 that includes a pair of opposed handles 161a, 161b. Each handle 161a, 161b generally includes a carrying arm 162 and a pair of side arms 163a, 163b. Each of the side arms 163a, 163b terminates at a fixation portion 164. Each handle 161a, 161b further comprises one or more projecting members 165 that can extend from one or both of the side arms 163a, 163b.

When using handle assembly 160, the housing 120 and lid assembly 130 can be modified so as to cooperatively define 1 a pair of engagement assemblies 166a, 166b. Each of the engagement assemblies 166a, 166b generally includes a lower housing engagement member 168 and an upper lid engagement member 170. Generally, the fixation portions 164 of each handle 161a, 161b are rotatably coupled to the corresponding lower housing engagement member 168 such that handles 161a, 161b individually rotate about a rotation axis 171 that is generally parallel to the opposed side walls 122a, 122b. As such, each of the handles 161a, 161b is individually rotatable between a lowered position 172 and a travel position 173. In a manner similar to that previously described with handle assembly 140, when the food item is positioned within the internal cooking volume 112 and the lid assembly 130 positioned over the upper opening 111, the user individually rotates the handles 161a, 161b from the lowered position 172 to the travel position 173. In the travel position 173, the projecting members 165 engage the corresponding upper lid engagement member 170 so as to compress the sealing gasket 137 against the upper sealing surface 113 and to lockably retain the lid assembly 130 over the upper opening 111 as the user grasps the carrying arms 162 and uses the handle assembly 160 to transport the slow cooker 100. Individually rotating the handles 161a, 161b from the travel position 173 to the lowered position 172 disengages the projecting the members 165 from the upper lid engagement members 170 and allows the lid assembly 130 to be rotated to the open position 151.

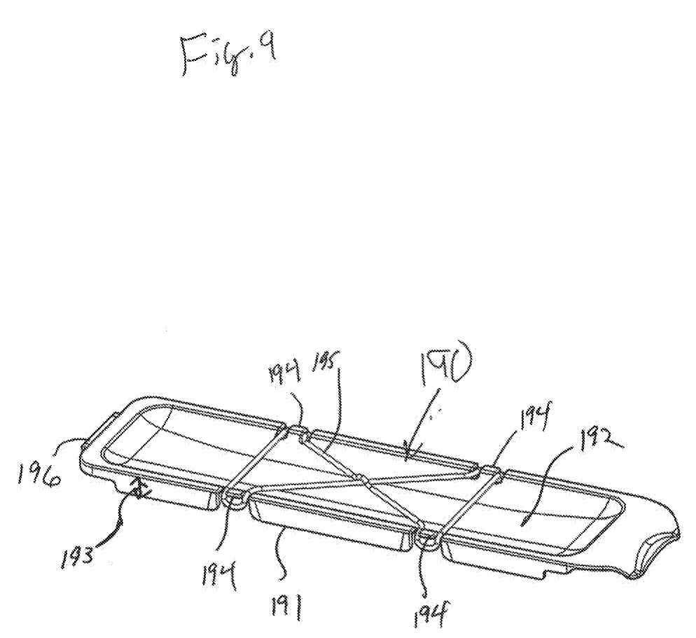

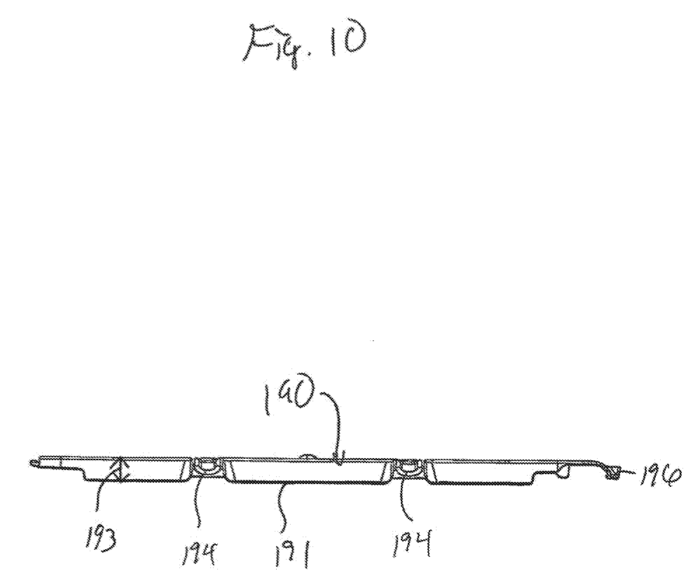

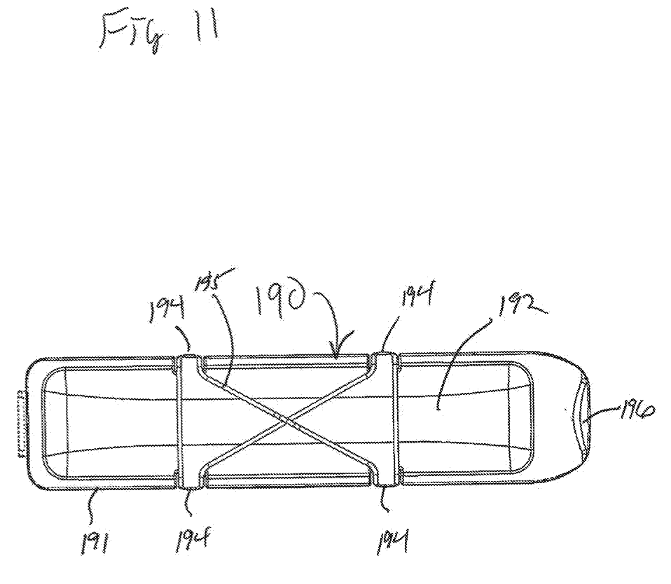

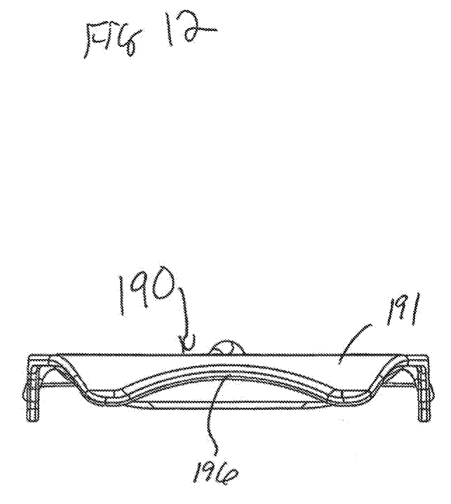

In some embodiments as shown in FIGS. 1-14, a utensil tray 190 can be removably mounted to between the lid cutouts 139a, 139b of the lid recessed portion 138. As illustrated, the utensil tray 190 can define a tray body 191 having a tray volume 192 defined by a tray depth 193. The utensil tray 190 can further define a plurality of mounting tabs 194 to which a flexible retention member 195 can be attached and retained over the tray volume 192. Flexible retention member 195 can comprise a resilient, stretchable material such as, for example, a rubber or silicone material having elastic properties. The utensil tray 190 can include one or more tray handles 196.

Generally, the utensil tray 190 can be snapped into the lid cutouts 139a, 139b such that the utensil tray 190 is removably coupled to the lid assembly 130. The user can then place a utensil, such as, for example, a serving fork or spoon, ladle, tongs, spatula or similar utensil, into the tray volume 192 such that the utensil is retained by the flexible retention member 195. At a serving location, the user can simply remove the utensil from the utensil tray 190 or alternatively, the user can snap the utensil tray 190 from the lid cutouts 139a, 139b and place the utensil tray 190 onto a serving surface proximate the slow cooker 100. When detached, the utensil tray 190 provides a convenient location to position the utensil alongside the slow cooker when the utensil is not being utilized. Furthermore, the tray volume 192 and more specifically, the tray depth 193 provides the utensil tray 190 with the ability to retain liquid materials such as for example, melted cheese, barbecue sauce and similar liquids to reduce spillage and simply cleanup

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A slow cooker, comprising:
a cooking vessel defining an interior portion and an upper opening;
a lid assembly rotatably mounted to the cooking vessel so as to selectively cover the upper opening; and
a handle assembly rotatably attached to the cooking vessel such that the handle assembly is rotatable between a lowered position and a travel position, said handle assembly configured to lockably retain the lid assembly over the upper opening when the handle assembly is in the travel position.

2. The slow cooker of claim 1, wherein the cooking vessel further comprises a hinge assembly mounted to an external rear wall of the cooking vessel and wherein the hinge assembly rotatably couples the lid assembly to the cooking vessel.

3. The slow cooker of claim 2, wherein the external rear wall includes a liquid drip tray, said liquid drip tray configured to receive liquid dripping from the lid assembly when the handle assembly is arranged in the lowered position and the lid assembly is rotated to an open position exposing the upper opening.

4. The slow cooker of claim 1, wherein the lid assembly include a pair of opposed lid side walls and wherein each of the lid side walls includes a retention member that is configured to be rotatably engaged by the handle assembly when the lid assembly is positioned to cover the upper opening and the handle assembly is rotated from the lowered position to the travel position.

5. The slow cooker of claim 4, wherein each retention member defines a retention tab, and wherein the handle assembly includes a carrying arm connecting a pair of opposed side arms with each opposed side arm defining an engagement cavity, wherein each engagement cavity is configured to rotatably engage the corresponding retention tab when the lid assembly is positioned to cover the upper opening and the handle assembly is rotated from the lowered position to the travel position.

6. The slow cooker of claim 5, wherein the handle assembly is rotatably coupled to the cooking vessel such that a path of rotation of the handle assembly is defined along an axis arranged transversely to a pair of opposed cooking vessel side walls.

7. The slow cooker of claim 4, wherein the handle assembly includes a pair of side handles with each side handle being individually rotatably mounted to one of a pair of opposed cooking vessel side walls.

8. The slow cooker of claim 7, wherein each retention member is configured as a lid handle.

9. The slow cooker of claim 8, wherein each lid handle includes at least one inwardly projecting member such that when the lid assembly is positioned to cover the upper opening and each side handle is rotated from the lowered position to the travel position, the at least one inwardly projecting member engages the corresponding lid handle.

10. The slow cooker of claim 9, wherein each side handle is individually rotatable coupled to the corresponding cooking vessel side wall such that a path of rotation of each side handle is defined along an axis arranged transversely to a cooking vessel front wall and a cooking vessel rear wall.

11. The slow cooker of claim 1, wherein the cooking vessel defines a pair of opposed vessel side walls, a vessel front wall and a vessel rear wall, wherein the vessel front wall and vessel rear wall are arranged in parallel relation and the pair of opposed vessel side walls are each arranged transversely to the vessel front wall and the vessel rear wall.

12. The slow cooker of claim 11, wherein the vessel front wall defines a display face that is arranged transversely to the pair of opposed vessel side walls.

13. The slow cooker of claim 12, wherein the display face includes a writing surface.

14. The slow cooker of claim 1, wherein the lid assembly defines an upper surface including a recessed portion and wherein a utensil tray is configured to be removable coupled within the recessed portion.

15. The slow cooker of claim 14, wherein the utensil tray defines an inner tray volume, the utensil tray further including a flexible retention member attached over the inner tray volume such that the flexible retention member is configured to retain one or more serving utensils within the inner tray volume.

16. A method of using the slow cooker of claim 1, comprising:
filling the interior portion of the cooking vessel with a food item;
rotatably lowering the lid assembly to cover the upper opening;
rotating the handle assembly from the lowered position to the travel position, whereby the handle assembly lockably engages lid assembly.

17. The method of claim 16, further comprising:
grasping the handle assembly and carrying the cooking vessel to a serving location with the handle assembly in the travel position and the lid assembly lockably covering the upper opening.

18. The method of claim 17, further comprising:
serving the food item at the serving location by rotating the handle assembly to the lowered position whereby the lid assembly can be rotated to expose the upper opening.

19. The method of claim 18, further comprising:
detaching a utensil tray from an upper surface of the lid assembly, whereby the utensil tray includes a flexible retention member configured to retain one or more serving utensils in an inner tray volume defined by the utensil tray.

20. The method of claim 19, further comprising:
removing the one or more serving utensils from the inner tray volume such that the one or more utensils can be used to serve the food item.
